(19) United States
(12) Patent Application Publication
(10) Pub. No.: US 2025/0225483 A1
(43) Pub. Date: Jul. 10, 2025

(54) MACHINE LEARNING APPARATUS, WBS CREATION APPARATUS, AND MACHINE LEARNING METHOD

(71) Applicant: MITSUBISHI ELECTRIC CORPORATION, Chiyoda-ku, Tokyo (JP)

(72) Inventor: Ippei NISHIMOTO, Tokyo (JP)

(73) Assignee: MITSUBISHI ELECTRIC CORPORATION, Chiyoda-ku, Tokyo (JP)

(21) Appl. No.: 18/703,769

(22) PCT Filed: Oct. 19, 2022
(86) PCT No.: PCT/JP2022/038871

§ 371 Date: Apr. 23, 2024

(30) Foreign Application Priority Data
Jan. 31, 2022 (WO) PCT/JP2022/003585

(51) Int. Cl. G06Q 10/10; G06N 20/00

(52) U.S. Cl. CPC G06Q 10/103; G06N 20/00

(57) ABSTRACT

An object is to provide a technique capable of creating an appropriate general-purpose WBS. A machine learning apparatus includes an acquisition part and a learning control part. The acquisition part acquires first information regarding a WBS work package of standard, second information regarding a WBS work package of a project corresponding to the standard, and third information regarding a process diagnosis result of a project corresponding to the standard. The learning control part performs learning regarding a WBS work package based on the first information, the second information, and the third information, thereby creating associated information associating the first information, the second information, and the third information.

### TECHNICAL FIELD

The present disclosure relates to a machine learning apparatus, a WBS creation apparatus, and a machine learning method.

### BACKGROUND ART

A project of developing a product is an action creating a product satisfying quality, a price, and a deadline required by a customer. However, particular in a software development in the project, it is difficult to determine whether or not an action satisfying quality, a price, and a deadline required by a customer is accomplished in a planned manner until the product is incorporated into a system. An application of a work breakdown structure (WBS) is proposed in the software development having such a problem.

The WBS is a system capable of clarifying all of operations from start to completion of the project completely. However, in a recent project, there is a tendency that the number of WBS work packages increases and complexity of connection between the WBS work packages increases. Furthermore, there is also a case where products having quality characteristics different from each other are parallelly created in the same organization. Difference of compliance of standard for which performance, extensibility, a technical operation, maintenance, a system environment, and ecology are particularly required in the quality characteristics complicates creation of the WBS for the project.

Various techniques are proposed to solve such a problem. For example, Patent Document 1 proposes a technique in which a management ID is assigned to deliverables, the management ID is accompanied with trace information, and trace information is registered in a traceability ID record terminal. Patent Document 2 proposes supervised learning in which a state variable and determination data are used as training data.

### PRIOR ART DOCUMENTS

### Patent Document(s)

Patent Document 1: Japanese Patent Application Laid-Open No. 2018-5802
Patent Document 2: Japanese Patent Application Laid-Open No. 2017-188030

### SUMMARY

### Problem to be Solved by the Invention

Conventionally, experts generally analyze a requirement received from a customer and create a base of the WBS from an appropriate reuse property extracted from past project results of an organization. However, this creation method has many elements depending on skills of the experts, and it is difficult to establish consistency of compliance of standard while appropriately incorporating the requirement received from the customer into the base of the WBS in a limited time.

Considered accordingly is performing learning based on information of standard, however, there is a problem that an appropriate WBS cannot be created from only the information of standard.

The present disclosure is therefore has been made to solve problems as described above, and it is an object of the present disclosure to provide a technique capable of creating an appropriate general-purpose WBS.

### Means to Solve the Problem

A machine learning apparatus according to the present disclosure includes: an acquisition part acquiring first information regarding a WBS work package of standard, second information regarding a WBS work package of a project corresponding to the standard, and third information regarding a process diagnosis result of a project corresponding to the standard; and a learning control part performing learning regarding a WBS work package based on the first information, the second information, and the third information, thereby creating associated information associating the first information, the second information, and the third information.

### Effects of the Invention

According to the present disclosure, learning regarding the WBS work package is performed based on the first information regarding the WBS work package of the standard, the second information regarding the WBS work package of the project corresponding to the standard, and the third information regarding the process diagnosis result of the project corresponding to the standard to create the associated information. According to such a configuration, an appropriate general-purpose WBS can be created.

These and other objects, features, aspects and advantages of the present disclosure will become more apparent from the following detailed description of the specification when taken in conjunction with the accompanying drawings.

### BRIEF DESCRIPTION OF DRAWINGS

FIG. 1 A block diagram illustrating an example of a configuration of a machine learning apparatus according to an embodiment 1.

FIG. 2 A flow chart for describing an example of a machine learning process according to the embodiment 1.

FIG. 3 A diagram illustrating an example of an ID management table according to the embodiment 1.

FIG. 4 A flow chart for describing an example of a machine learning process according to the embodiment 1.

FIG. 5 A diagram illustrating an example of a terminology management table according to the embodiment 1.

FIG. 6 A flow chart for describing an example of a machine learning process according to the embodiment 1.

FIG. 7 A diagram illustrating an example of a general-purpose WBS task table according to the embodiment 1.

FIG. 8 A diagram illustrating an example of a general-purpose WBS link table according to the embodiment 1.

FIG. 9 A diagram illustrating an example of a link type according to the embodiment 1.

FIG. 10 A diagram illustrating a configuration example of a neural network.

FIG. 11 A block diagram illustrating an example of a configuration of a WBS creation apparatus according to an embodiment 2.

FIG. 12 A diagram illustrating an example of an input screen of an information input part according to the embodiment 2.

FIG. 13 A diagram illustrating an example of an output screen of an information output part according to the embodiment 2.

FIG. 14 A diagram illustrating an example of the output screen of the information output part according to the embodiment 2.

FIG. 15 A block diagram illustrating a hardware configuration of the machine learning apparatus according to another modification example.

FIG. 16 A block diagram illustrating a hardware configuration of the machine learning apparatus according to another modification example.

### DESCRIPTION OF EMBODIMENT(S)

### Embodiment 1

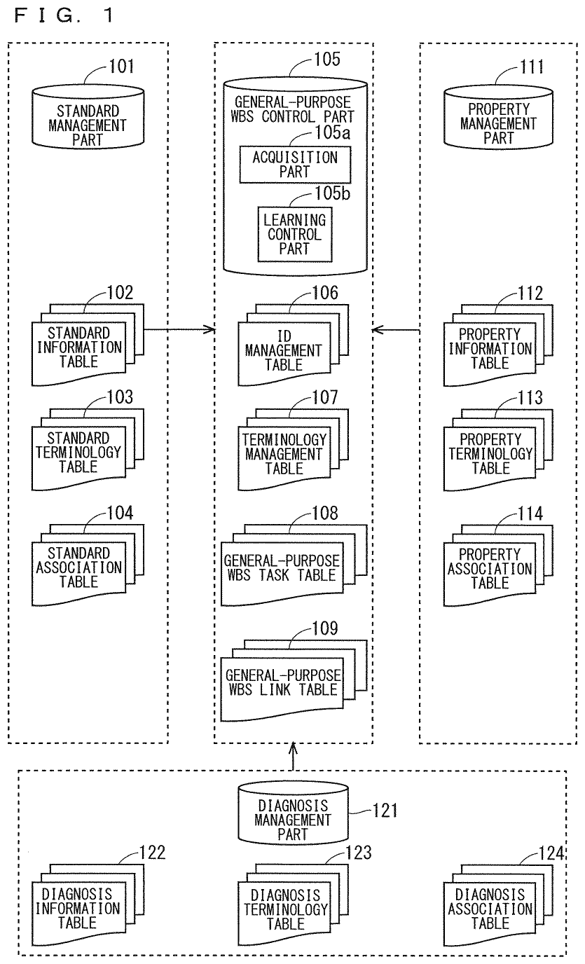

FIG. 1 is a block diagram illustrating an example of a configuration of a machine learning apparatus according to the present embodiment 1. The machine learning apparatus in FIG. 1 includes a standard management part 101, a general-purpose WBS control part 105, a property management part 111, and a diagnosis management part 121. At least one of the standard management part 101, the general-purpose WBS control part 105, the property management part 111, or the diagnosis management part 121 may be provided to one terminal or dispersedly provided to a plurality of terminals. The machine learning apparatus in FIG. 1 may be provided to a cloud server.

The standard management part 101 manages first information regarding a WBS work package of standard. The property management part 111 manages second information regarding a WBS work package of a project corresponding to a standard. The diagnosis management part 121 manages third information regarding a rating result of a process diagnosis result of a project corresponding to a standard. The project corresponding to the standard includes a project reusing a standard, for example. In the description hereinafter, the project corresponding to the standard is simply referred to as only “the project” in some cases. The first information may include the WBS work package itself, and the second information may include the WBS work package itself of the project.

The general-purpose WBS control part 105 performs learning regarding a WBS work package based on the first information, the second information, and the third information managed in the standard management part 101 and the property management part 111, thereby creating associated information associating the first information, the second information, and the third information. The learning regarding the WBS work package may be learning of the WBS work package itself.

The associated information created by this learning is used for creating a general-purpose WBS. The associated information according to the present embodiment 1 includes at least one of an ID management table 106, a terminology management table 107, a general-purpose WBS task table 108, or a general-purpose WBS link table 109. However, the associated information is not limited thereto, but may include a table other than these tables, for example.

The standard management part 101 manages a standard information table 102, a standard terminology table 103, a standard association table 104, for example, as the first information. Registered in the standard information table 102 is a WBS work package including a technical process action, a management process action, and an assist process action based on information defined by the standard. Meaning of a terminology defined by the standard is registered in the standard terminology table 103. A name of the standard and a name of the other standard associated with the standard are registered in the standard association table 104.

The property management part 111 manages a property information table 112, a property terminology table 113, and a property association table 114, for example, as the second information. Registered in the property information table 112 is a WBS work package including a technical process action, a management process action, and an assist process action executed in a past project. Meaning of the terminology defined by the project is registered in the property terminology table 113. A name of the project created by reusing the standard that the project complies with is registered in the property association table 114.

The diagnosis management part 121 manages a diagnosis information table 122, a diagnosis terminology table 123, and a diagnosis association table 124, for example, as the third information. Registered in the diagnosis information table 122 is a rating result including a technical process action, a management process action, and an assist process action diagnosed in a past project. Meaning of the terminology defined by the project is registered in the diagnosis terminology table 123. A name of the project created by reusing the standard that the project complies with is registered in the diagnosis association table 124.

The general-purpose WBS control part 105 includes an acquisition part 105a and a learning control part 105b. The acquisition part 105a acquires the first information from the standard management part 101, acquires the second information from the property management part 111, and acquires the third information from the diagnosis management part 121. The acquisition part 105a may acquire the first information, the second information, and the third information from the network.

The learning control part 105b has a machine learning function, and performs learning regarding the WBS work package based on the first information, the second information, and the third information, thereby creating associated information associating the first information, the second information, and the third information. The associated information according to the present embodiment 1 includes at least one of the ID management table 106, the terminology management table 107, the general-purpose WBS task table 108, or the general-purpose WBS link table 109.

The ID management table 106 is a table recording an identifier identifying a standard or a project, an identifier of a standard or a project regarding the standard or the project, a name of a standard or a project, and a version management. That is to say, the ID management table 106 includes a name of at least one of the standard or the project.

The terminology management table 107 is a table recording an identifier identifying a standard or a project, an identifier identifying the other standard or the other project using the same terminology as the standard or the project, and a defined terminology. That is to say, the terminology management table 107 includes a terminology of at least one of the standard or the project.

The general-purpose WBS task table 108 is a table recording an identifier identifying a WBS work package used for a general-purpose WBS, an identifier of a standard in which the WBS work package used for the general-purpose WBS is defined, and contents of the WBS work package used for the general-purpose WBS. That is to say, the general-purpose WBS task table 108 includes the contents of the WBS work package.

The general-purpose WBS link table 109 is a table recording a link type between WBS work packages used for a general-purpose WBS, an identifier of a WBS work package used for the general-purpose WBS of a link source, and an identifier of the WBS work package used for the general-purpose WBS of a link destination. That is to say, the general-purpose WBS link table 109 includes trace information associating the WBS work packages.

The learning control part 105b performs supervised learning using the standard information table 102 and the standard association table 104, thereby creating the ID management table 106. The learning control part 105b performs reinforcement learning using the property information table 112 and the property association table 114, thereby reinforcing the ID management table 106. The learning control part 105b performs reinforcement learning using the diagnosis information table 122 and the diagnosis association table 124, thereby reinforcing the ID management table 106.

The learning control part 105b performs supervised learning using the standard terminology table 103 and the standard association table 104, thereby creating the terminology management table 107. The learning control part 105b performs reinforcement learning using the property terminology table 113 and the property association table 114, thereby reinforcing the terminology management table 107. The learning control part 105b performs reinforcement learning using the diagnosis terminology table 123 and the diagnosis association table 124, thereby reinforcing the terminology management table 107.

The learning control part 105b performs supervised learning using the ID management table 106, the terminology management table 107, and contents of the WBS work package of a standard recorded in the standard information table 102, thereby creating the general-purpose WBS task table 108. The learning control part 105b performs reinforcement learning using the ID management table 106, the terminology management table 107, and contents of the WBS work package of a project recorded in the property information table 112, thereby reinforcing the general-purpose WBS task table 108. The learning control part 105b performs reinforcement learning using the ID management table 106, the terminology management table 107, and contents of a process diagnosis result of a project recorded in the diagnosis information table 122, thereby reinforcing the general-purpose WBS task table 108.

The learning control part 105b performs supervised learning using the ID management table 106, the terminology management table 107, and correlated information of the WBS work package of a standard recorded in the standard information table 102, thereby creating the general-purpose WBS link table 109. The learning control part 105b performs reinforcement learning using the ID management table 106, the terminology management table 107, and correlated information of the WBS work package of a project recorded in the property information table 112, thereby reinforcing the general-purpose WBS link table 109. The learning control part 105b performs reinforcement learning using the ID management table 106, the terminology management table 107, and correlated information of a process diagnosis result of a project recorded in the diagnosis information table 122, thereby reinforcing the general-purpose WBS link table 109.

When there is a shortage of general-purpose WBS information of the general-purpose WBS task table 108 and the general-purpose WBS link table 109, missing information may be manually registered. The supervised learning may also be performed in place of the reinforcement learning in the above description, for example.

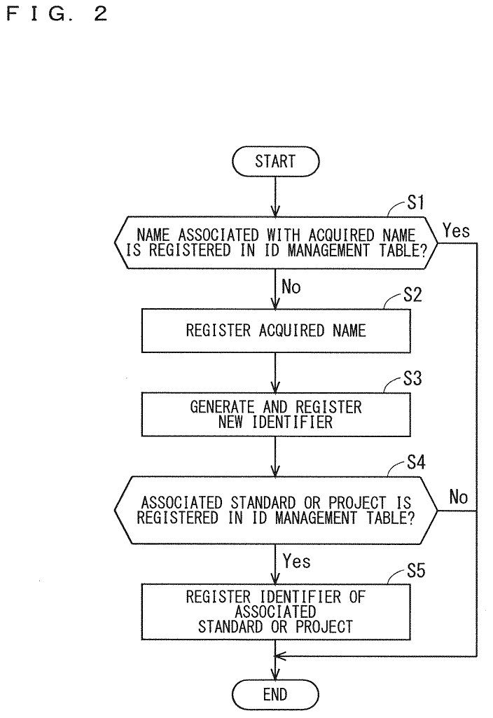

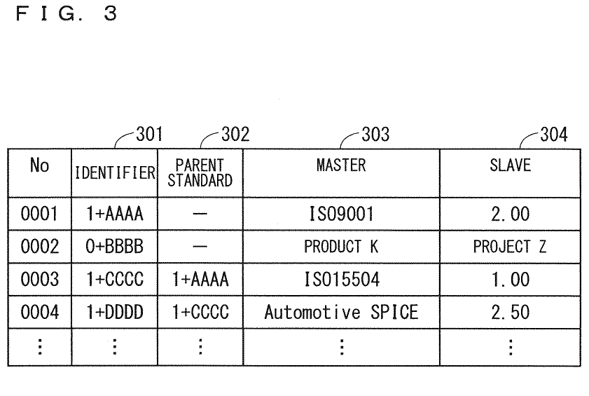

FIG. 2 is a flow chart for describing an example of the machine learning process in the learning control part 105b regarding the ID management table 106. FIG. 3 illustrates an example of the ID management table 106.

Although not shown in the diagrams, when the machine learning process regarding the ID management table 106 is started, the acquisition part 105a acquires a name of a standard or a project from the standard association table 104, the property association table 114, or the diagnosis association table 124. The name acquired in the acquisition part 105a is referred to as “acquired name” and described hereinafter.

In Step S1, the learning control part 105b determines whether or not a name coinciding with the acquired name is registered in data 303 and data 304 in the ID management table 106. When it is determined that they coincide with each other, the process in FIG. 2 is finished, and when it is determined that they do not coincide with each other, the process proceeds to Step S2.

In Step S2, the learning control part 105b registers the acquired name in the data 303 and the data 304. For example, a popular name of the acquired name is registered in a master of the data 303, and a version of the acquired name is registered in a slave of the data 304.

In Step S3, the learning control part 105b creates an identifier for identifying the acquired name, and registers the identifier in data 301.

In Step S4, the learning control part 105b determines whether or not a past standard or a past project associated with the standard or the project indicated by the acquired name is registered in the ID management table 106. For example, when the learning control part 105b determines that the past standard is diverted to the standard indicated by the acquired name based on the standard information table 102, it is determined that the standard indicated by the acquired name is associated with the past standard. For example, when the learning control part 105b determines that the past project is diverted to the project indicated by the acquired name based on the standard information table 102, the property information table 112, and the diagnosis information table 122, it is determined that the project indicated by the acquired name is associated with the past project.

When it is determined that the standard or the project indicated by the acquired name is associated with the past standard or the past project, the process proceed to Step S5. When it is determined that the standard or the project indicated by the acquired name is not associated with the past standard or the past project, the process in FIG. 2 is finished.

In Step S5, the learning control part 105b registers the identifier of the past standard or the pas project in the data 302 of the acquired name associated with the past standard or the past project. Subsequently, the process in FIG. 2 is finished. The learning control part 105b performs learning, thus the determination in Step S4 is made appropriate, for example, and the ID management table 106 in FIG. 3 is made appropriate.

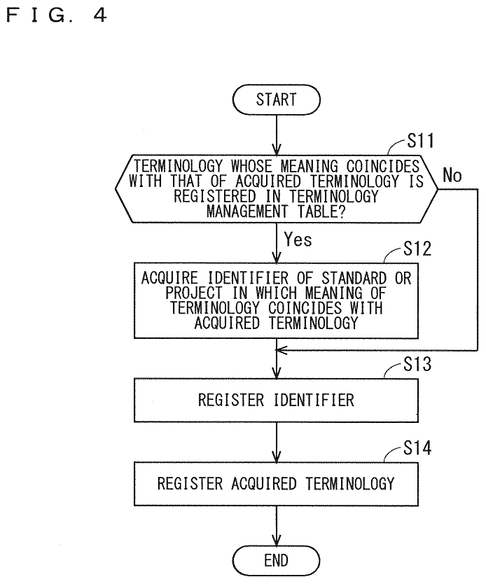

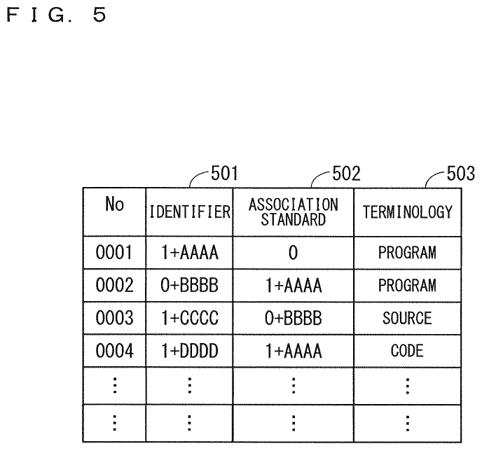

FIG. 4 is a flow chart for describing an example of the machine learning process in the learning control part 105b regarding the terminology management table 107. FIG. 5 illustrates an example of the terminology management table 107.

The machine learning process in the learning control part 105b regarding the terminology management table 107 is performed on the standard or the project in which the identifier is created in Step S3 in FIG. 2, for example. Although not shown in the diagrams, when the machine learning process is started, the acquisition part 105a acquires a terminology, for example, used for the standard or the project in which the identifier is created in Step S3 from the standard terminology table 103, the property terminology table 113, or the diagnosis terminology table 123. The terminology acquired in the acquisition part 105a is referred to as “acquired terminology” and described hereinafter.

In Step S11, the learning control part 105b determines whether or not a terminology whose meaning coincides with that of the acquired terminology is registered in data 503 in the terminology management table 107. When it is determined that they coincide with each other, the process proceeds to Step S12, and when it is determined that they do not coincide with each other, the process proceeds to Step S13.

In Step S12, the learning control part 105b acquires an identifier of a past standard or a past project using a terminology in which it is determined that meaning thereof coincides with the acquired terminology in Step S11 from data 501 in the terminology management table 107.

In Step S13, the learning control part 105b registers the identifier created in Step S3 in FIG. 2 in the data 501. When the learning control part 105b performs the process in Step S12, the learning control part 105b registers the identifier acquired in Step S12 in data 502.

In Step S14, the learning control part 105b registers the acquired terminology in the data 503. Subsequently, the process in FIG. 4 is finished. The learning control part 105b performs learning, thus the determination in Step S11 is made appropriate, for example, and the terminology management table 107 in FIG. 5 is made appropriate.

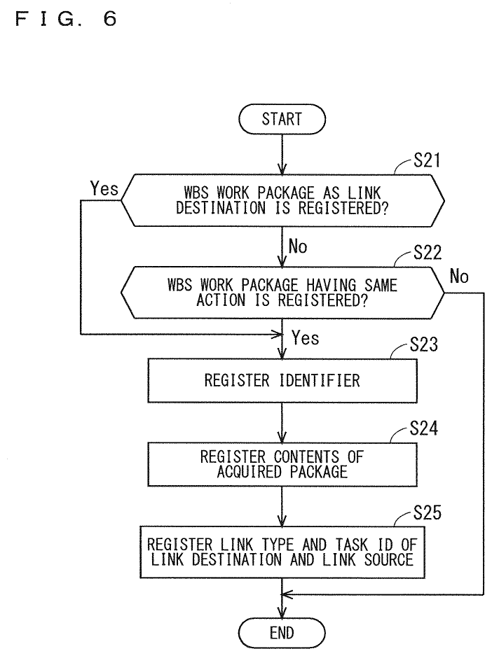

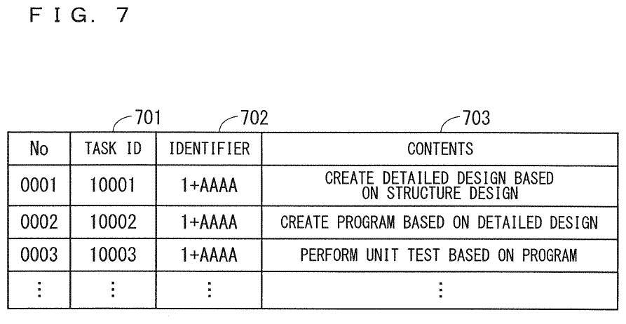

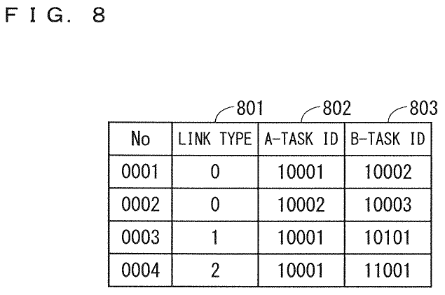

FIG. 6 is a flow chart for describing an example of the machine learning process in the learning control part 105b regarding the general-purpose WBS task table 108 and the general-purpose WBS link table 109. FIG. 7 illustrates an example of the general-purpose WBS task table 108, and FIG. 8 illustrates an example of the general-purpose WBS link table 109.

The machine learning process in the learning control part 105b regarding the general-purpose WBS task table 108 and the general-purpose WBS link table 109 is performed on the standard or the project in which the identifier is created in Step S3 in FIG. 2, for example. Although not shown in the diagrams, when the machine learning process is started, the acquisition part 105a acquires the WBS work package used for the standard or the project in which the identifier is created in Step S3, for example, from the standard information table 102, the property information table 112, or the diagnosis information table 122. The WBS work package acquired in the acquisition part 105a is referred to as “acquired package” and described hereinafter.

In Step S21, the learning control part 105b determines whether or not the WBS work package as a link destination of the acquired package is registered in the general-purpose WBS task table 108 and the general-purpose WBS link table 109. When it is determined that the WBS work package as the link destination of the acquired package is registered, the process proceeds to Step S23, and when it is determined that the WBS work package as the link destination of the acquired package is not registered, the process proceeds to Step S22.

In Step S22, the learning control part 105b determines whether or not the WBS work package having the same action as the acquired package is registered in the general-purpose WBS task table 108 and the general-purpose WBS link table 109. When it is determined that the WBS work package having the same action as the acquired package is registered, the process proceeds to Step S23, and when it is determined that the WBS work package having the same action as the acquired package is not registered, the process in FIG. 6 is finished.

In Step S23, the learning control part 105b creates a task ID and registers the task ID in data 701, and registers the identifier created in Step S3 in FIG. 2 in the data 702.

In Step S24, the learning control part 105b registers contents of the acquired package in the data 703.

In Step S25, the learning control part 105b registers a link type in data 801 base on task information of the WBS work package. The learning control part 105b registers, in data 802, the task ID of the WBS work package as the link destination in the data 701, and registers, in data 803, the task ID of the WBS work package as the link source in the data 701. Subsequently, the process in FIG. 6 is finished. The learning control part 105b performs learning, thus the registration in Step S24 is made appropriate, for example, and the general-purpose WBS task table 108 in FIG. 7 and the general-purpose WBS link table 109 in FIG. 8 are made appropriate.

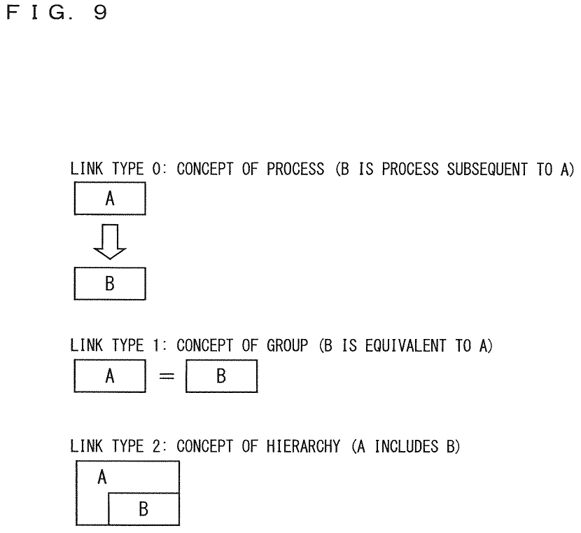

FIG. 9 is a diagram for describing an example of the link type in FIG. 8. A state where the link type is 0 indicates that the link destination is a next process for the link source. A state where the link type is 1 indicates that the link destination and the link source are equivalent processes. A state where the link type is 2 indicates that the link destination is a part of a process of the link source.

The process in Step S1 to Step S5 in FIG. 2, the process in Step S11 to Step S14 in FIG. 4, and the process in Step S21 to Step S25 in FIG. 6 are repetitively executed until the learning control part 105b sufficiently learns a general-purpose WBS work package. The WBS work package of the standard or the project is preferably mounted in patterns of a plurality of link types.

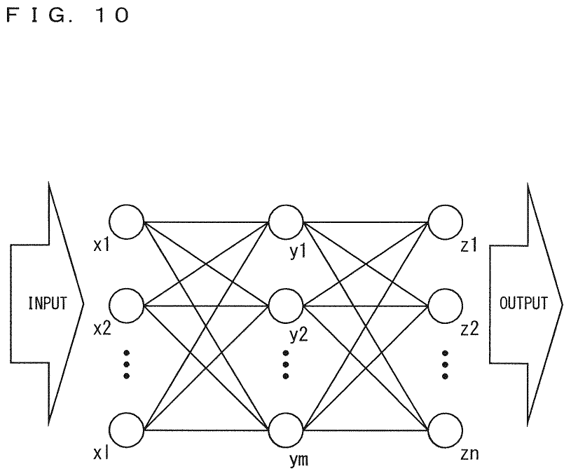

FIG. 10 is a diagram illustrating a configuration example of a neural network. A design review achievement prediction may be learned in accordance with a neural network model, for example, in the machine learning of the learning control part 105b. As illustrated in FIG. 10, the neural network includes an input layer including one neuron x1, x2, x3, . . . , or xl, an intermediate layer (hidden layer) including m numbers of neurons y1, y2, y3, . . . , and ym, and an output layer including n numbers of neurons z1, z2, z3, . . . , and zn. The intermediate layer including only one layer is provided in the configuration example of the neural network in FIG. 10, however, the intermediate layer including two or more layers may be provided. A general-purpose calculator or processor may be used for the machine learning (neural net) of the learning control part 105b, and the process can be performed at a higher speed by applying a large scale PC cluster, for example, to the machine learning.

In the neural network, learning of the ID management table 106, the terminology management table 107, the general-purpose WBS task table 108, or the general-purpose WBS link table 109 associated with the general-purpose WBS work package, that is to say, learning of the associated information may be performed. In the neural network, the associated information associating the WBS work package of the standard and the project, for example, may be learned by a so-called “supervised learning” in accordance with a verification result based on a combination of the associated information and the determination data indicating right or wrong of the associated information. Herein, “supervised learning” indicates learning providing many groups of a certain input and a result (label) to a learning apparatus, thereby learning characteristics included in verification result thereof, and capable of inductively acquiring a model estimating the result from the input, that is to say, a relationship between the input and the result.

The machine learning of the learning control part 105b is not limited to “supervised learning”. For example, it is applicable that only correct associated information, that is to say, only the ID management table 106, the terminology management table 107, the general-purpose WBS task table 108, or the general-purpose WBS link table 109 normally satisfying a verification standard is accumulated using the neural network, and the general-purpose work package is learned by a so-called “unsupervised learning”. For example, when a degree of achievement of the verification result of the ID management table 106, the terminology management table 107, the general-purpose WBS task table 108, or the general-purpose WBS link table 109 is extremely high, a method of “unsupervised learning” is considered to be effective.

Herein, “unsupervised learning” indicates learning capable of compressing, classifying, and forming input data by learning a type of distribution of the input data by providing only many pieces of input data without providing corresponding supervised data. According to this learning, clustering for classification into a similar verification result can be performed. When performed is allocation of output to optimize the data by providing a certain standard using this result, prediction of the output can be achieved.

The general-purpose WBS work package may be learned by learning referred to as “semi-supervised learning” intermediating between “unsupervised learning” and “supervised learning”. “Semi-supervised learning” is effective in a case where a group of data of input and output is partially included, and data of only input is included in the other part.

### <Conclusion of Embodiment 1>

According to the present embodiment 1, learning regarding the WBS work package is performed based on not only the first information regarding the WBS work package of the standard, but also the second information regarding the WBS work package of the project and the third information regarding the process diagnosis result of the project to create the associated information. According to such a configuration, missing contents in the first information can be compensated by the second information or the third information, thus the learning regarding the WBS work package can be appropriately performed, and as a result, the associated information capable of creating the appropriate general-purpose WBS can be created. That is to say, even when a factor of increasing achievement of the verification result is complex and it is difficult to previously set the WBS work package of the project, a prediction model capable of creating a high-accuracy WBS can be created.

The learning control part 105b may learn the ID management table 106, the terminology management table 107, the general-purpose WBS task table 108, or the general-purpose WBS link table 109 as the learning regarding the WBS work package described above. The learning control part 105b may perform learning regarding the WBS work package based on the first information, the second information, and the third information acquired from the plurality of standard management parts 101, the plurality of property management parts 111, and the plurality of diagnosis management parts 121 activated in the same development field. The learning control part 105b may perform learning regarding the WBS work package based on the first information, the second information, and the third information acquired from the plurality of standard management parts 101, the plurality of property management parts 111, and the plurality of diagnosis management parts 121 independently activated in different development fields. Any one of the standard management part 101, the property management part 111, and the diagnosis management part 121 may be added to a target from which the first information, the second information, and the third information are acquired midway through the process or removed from the target midway through the process.

The verification result may be shared (commonly used) in the plurality of general-purpose WBS control parts 105. As a first example, a model of the same neural network may be shared in the plurality of general-purpose WBS control parts 105. Specifically, each weight coefficient of the network for reflecting a difference between the plurality of general-purpose WBS control parts 105 may be transmitted using a communication means. As a second example, weight of the machine learning may be shared by sharing the verification result of the input and the output of the neural network. As a third example, a state may be shared so that a similar model is used by having access to a database which is previously prepared to load a more appropriate model of the neural network. Share of the verification result of the plurality of general-purpose WBS control parts 105 is not limited to the first example to the third example.

### Embodiment 2

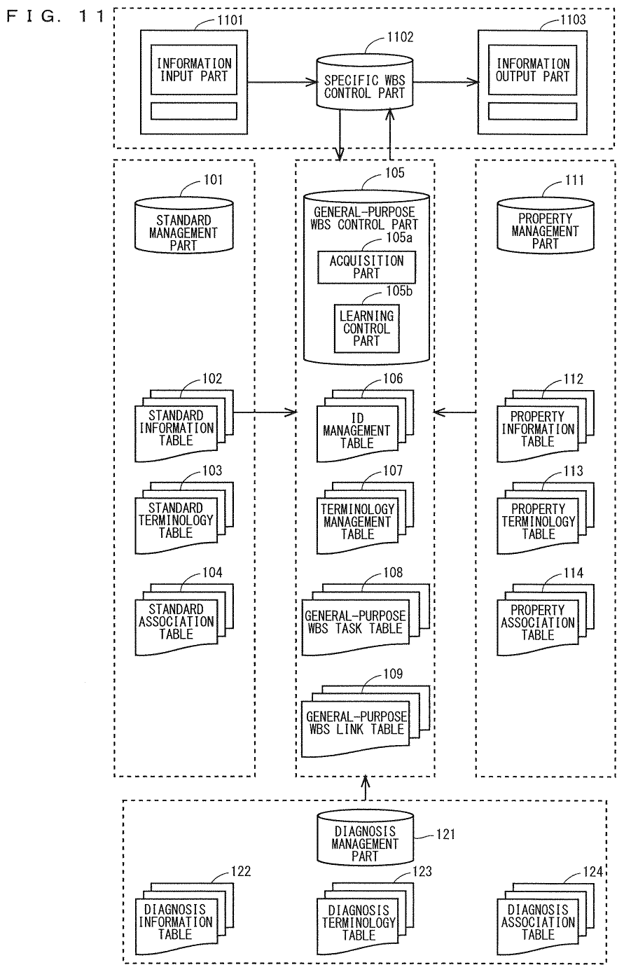

FIG. 11 is a block diagram illustrating an example of a configuration of a WBS creation apparatus according to the present embodiment 2. In the description hereinafter, the WBS creation apparatus according to the present embodiment 2 is a specific WBS creation apparatus creating a specific WBS work package of the project. The same or similar reference numerals as those described above will be assigned to the same or similar constituent elements according to the present embodiment 2, and the different constituent elements are mainly described hereinafter.

As illustrated in FIG. 11, the WBS creation apparatus according to the present embodiment 2 has a configuration similar to the machine learning apparatus in FIG. 1 described in the embodiment 1 except that an information input part 1101, a specific WBS control part 1102, and an information output part 1103 are added.

The information input part 1101 acquires a current project or a standard corresponding to the current project, for example, as input information. The specific WBS control part 1102 acquires associated information of the general-purpose WBS work package created by the machine learning from the general-purpose WBS control part 105, for example, based on the input information. The specific WBS control part 1102 creates a specific WBS work package or a specific WBS of the current project corresponding to a development scale or a degree of change of the project based on the input information and the associated information. The information output part 1103 outputs a specific WBS work package or a specific WBS created in the specific WBS control part 1102.

In the present embodiment 2, the project in which the second information used in the machine learning is acquired may be a past project as with the embodiment 1 or a current new project inputted to the information input part 1101.

In a configuration of creating the specific WBS work package as with the present embodiment 2, the neural network model may be used. For example, the output layer may calculate compatibility between a verification result inputted to the input layer of the neural network and information indicating pass or fail of achievement on the general-purpose WBS work package or the WBS work package which is to be valid. Then, the output layer may output the information indicating pass or fail of achievement on the general-purpose WBS work package or the WBS work package which is to be valid.

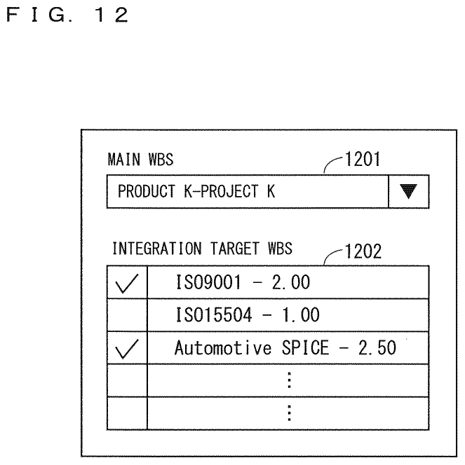

FIG. 12 is a diagram illustrating an example of an input screen of the information input part 1101. A main WBS selection screen 1201 displays a name of the project acquired from the ID management table 106 of the general-purpose WBS control part 105 to be able to select the name thereof. As the display of the name of the project, a list of names of all of the projects may be displayed, or the name of the project may be displayed in a pull-down form.

An integration target WBS selection screen 1202 displays a name of the standard acquired from the ID management table 106 of the general-purpose WBS control part 105 to be able to select the name thereof. As the display of the name of the standard, a list of names of all of the projects may be displayed, or the name of the project may be displayed in a pull-down form. When the project is displayed on the main WBS selection screen 1201, the integration target WBS selection screen 1202 may display the standard associated with the project (standard that the project complies with, for example) while being assigned with a check mark previously. The integration target WBS selection screen 1202 may add or delete the standard associated with the project as necessary.

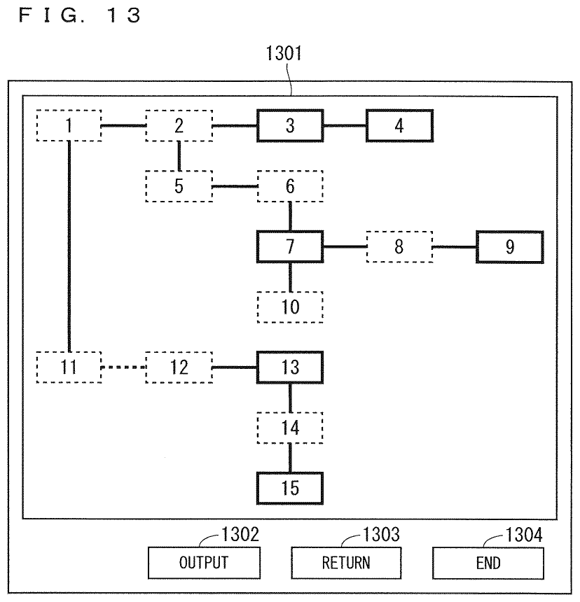

FIG. 13 is a diagram illustrating an example of an output screen of the information output part 1103. The specific WBS control part 1102 acquires the standard associated with the project selected in the information input part 1101 from the general-purpose WBS work package registered in the general-purpose WBS task table 108 and the general-purpose WBS link table 109 in the general-purpose WBS control part 105. Then, the specific WBS control part 1102 creates the specific WBS based on the input information and the acquired standard, and the specific WBS output screen 1301 displays the created specific WBS.

When the WBS work package newly added to the project is included, the specific WBS output screen 1301 may highlight and display the added WBS work package. When the plurality of WBS work packages newly added to the project are included, the information output part 1103 may have a configuration of being able to select one WBS work package from the plurality of WBS work packages.

The specific WBS output screen 1302 is a button for starting output of the project of the selected WBS work package. The output form may be a text form or a file form corresponding to the other application tool.

In the present embodiment 2, the information input part 1101 and the information output part 1103 are selectively displayed in one screen, and the specific WBS output screen 1303 is a button for returning to the display in FIG. 12. The specific WBS output screen 1304 is a button for finishing an operation of the WBS creation apparatus.

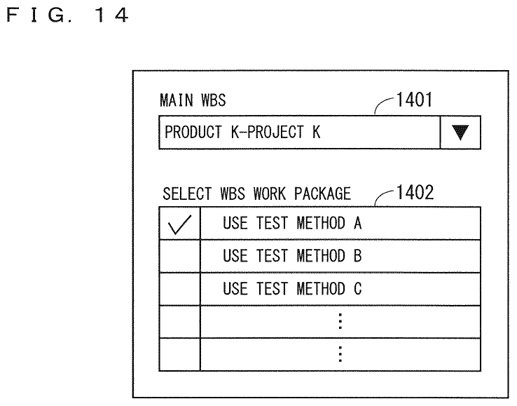

FIG. 14 is a diagram illustrating an example of the output screen of the information output part 1103, and specifically is a diagram illustrating an example of the selection screen in the case where the plurality of WBS work packages newly added to the project are included. A main WBS definite screen 1401 displays a name of a project selected in the main WBS selection screen 1201 of the information input part 1101, for example.

A WBS work package selection screen 1402 displays, for example, a list of the names of the plurality of WBS work packages falling under the selected project so that the names thereof can be selected. When the project is displayed on the main WBS definite screen 1401, the WBS work package selection screen 1402 may display the plurality of WBS work packages newly added to the project while being assigned with a check mark previously.

There is a case where the WBS work package newly added to the project is not included in an actual operation. In such a case, the WBS work package selection screen 1402 may display the WBS work package of the other standard or the other project closely related to the standard associated with the project. A work package used for the project can be selected from the plurality of WBS work packages in the WBS work package selection screen 1402.

### <Conclusion of Embodiment 2>

In the present embodiment 2, the WBS of the current project is created based on the information of the current project and the associated information. According to such a configuration, an appropriate specific WBS can be created.

### Another Modification Example

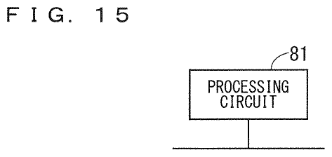

The acquisition part 105a and the learning control part 105b in FIG. 1 described above are referred to as “the acquisition part 105a etc.” hereinafter. The acquisition part 105a etc. is achieved by a processing circuit 81 illustrated in FIG. 15. That is to say, the processing circuit 81 includes the acquisition part 105a acquiring the first information regarding the WBS work package of the standard, the second information regarding the WBS work package of the project corresponding to the standard, and the third information regarding the process diagnosis result of the project corresponding to the standard and the learning control part 105b performing learning regarding the WBS work package based on the first information, the second information, and the third information, thereby creating the associated information associating the first information, the second information, and the third information. Dedicated hardware may be applied to the processing circuit 81, or a processer executing a program stored in a memory may also be applied. Examples of the processor include a central processing unit, a processing device, an arithmetic device, a microprocessor, a microcomputer, or a digital signal processor (DSP).

When the processing circuit 81 is the dedicated hardware, a single circuit, a complex circuit, a programmed processor, a parallel-programmed processor, an application specific integrated circuit (ASIC), a field-programmable gate array (FPGA), or a combination of them, for example, falls under the processing circuit 81. Each function of the acquisition part 105a etc. may be achieved by circuits to which the processing circuit is dispersed, or each function of them may also be collectively achieved by one processing circuit.

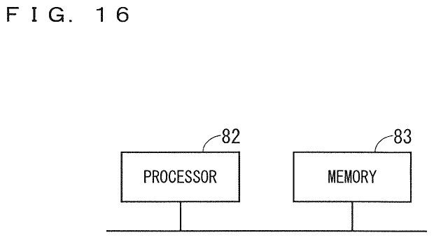

When the processing circuit 81 is the processor, the functions of the acquisition part 105a etc. are achieved by a combination with software etc. Software, firmware, or software and firmware, for example, fall under the software etc. The software etc. is described as a program and is stored in a memory. As illustrated in FIG. 16, a processor 82 applied to the processing circuit 81 reads out and executes a program stored in the memory 83, thereby achieving the function of each unit. That is to say, the machine learning apparatus includes the memory 83 for storing a program resultingly executing a step of acquiring the first information regarding the WBS work package of the standard, the second information regarding the WBS work package of the project corresponding to the standard, and the third information regarding the process diagnosis result of the project corresponding to the standard and a step of performing learning regarding the WBS work package based on the first information, the second information, and the third information, thereby creating the associated information associating the first information, the second information, and the third information. In other words, this program is also deemed to make a computer execute a procedure or a method of the acquisition part 105a etc. Herein, the memory 83 may be a non-volatile or volatile semiconductor memory such as a random access memory (RAM), a read only memory (ROM), a flash memory, an erasable programmable read only memory (EPROM), or an electrically erasable programmable read only memory (EEPROM), a hard disk drive (HDD), a magnetic disc, a flexible disc, an optical disc, a compact disc, a mini disc, a digital versatile disc (DVD), or a drive device of them, or any storage medium which is to be used in the future.

Described above is the configuration that each function of the acquisition part 105a etc. is achieved by one of the hardware and the software, for example. However, the configuration is not limited thereto, but also applicable is a configuration of achieving a part of the acquisition part 105a etc. by dedicated hardware and achieving another part of them by software, for example. For example, the function of the acquisition part 105a can be achieved by the processing circuit 81 as the dedicated hardware, an interface, and a receiver, for example, and the function of the other units can be achieved by the processing circuit 81 as the processor 82 reading out and executing the program stored in the memory 83.

As described above, the processing circuit 81 can achieve each function described above by the hardware, the software, or the combination of them, for example.

Each embodiment and each modification example can be arbitrarily combined, or each embodiment and each modification example can be appropriately varied or omitted.

The foregoing description is in all aspects illustrative and does not restrict the invention. It is therefore understood that numerous modification examples can be devised.

### EXPLANATION OF REFERENCE SIGNS

105a acquisition part, 105b learning control part.

1. A machine learning apparatus, comprising:
an acquisition circuitry acquiring first information regarding a WBS work package of standard, second information regarding a WBS work package of a project corresponding to the standard, and third information regarding a process diagnosis result of a project corresponding to the standard; and
a learning control circuitry performing learning regarding a WBS work package based on the first information, the second information, and the third information, thereby creating associated information associating the first information, the second information, and the third information.

2. The machine learning apparatus according to claim 1, wherein
the associated information includes contents of the WBS work package.

3. The machine learning apparatus according to claim 1, wherein
the associated information includes trace information associating the WBS work packages.

4. The machine learning apparatus according to claim 1, wherein
the associated information includes at least one terminology and at least one name of any of the standard or the project.

5. The machine learning apparatus according to claim 1, wherein
the associated information includes at least one of a terminology or a name of diagnosis information.

6. The machine learning apparatus according to claim 1, wherein
the acquisition circuitry acquires the first information and the second information from a network.

7. The machine learning apparatus according to claim 1, wherein
the project in which the second information is acquired includes a current project.

8. The machine learning apparatus according to claim 1, wherein
the machine learning apparatus is provided to a cloud server.

9. A WBS creation apparatus, comprising
the machine learning apparatus according to claim 1, wherein
a WBS of a current project is created based on information of the current project and the associated information.

10. A machine learning method, comprising:
acquiring first information regarding a WBS work package of standard, second information regarding a WBS work package of a project corresponding to the standard, and third information regarding a process diagnosis result of a project corresponding to the standard; and
performing learning regarding a WBS work package based on the first information, the second information, and the third information, thereby creating associated information associating the first information, the second information, and the third information.
